(19) United States
(12) Patent Application Publication
(10) Pub. No.: US 2009/0066900 A1
(43) Pub. Date: Mar. 12, 2009

(54) LIQUID CRYSTAL DISPLAY

(75) Inventors: Hong-Jo PARK, Suwon-si (KR); Hee-Seop KIM, Hwaseong-si (KR); JianGang LU, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/114,337

(22) Filed: May 2, 2008

(30) Foreign Application Priority Data
Sep. 12, 2007 (KR) 10-2007-0092696

(51) Int. Cl. G02F 1/1333; G02F 1/1343

(52) U.S. Cl. 349/138; 349/139

(57) ABSTRACT

A liquid crystal display (LCD) includes a first substrate, a pixel electrode disposed on the first substrate and including a plurality of domain-forming units, a pixel-electrode-insulating film disposed on the pixel electrode, and a director control electrode disposed on the pixel-electrode-insulating film positioned between the plurality of domain-forming units.

### CROSS-REFERENCE TO RELATED APPLICATION

This application claims priority from and the benefit of Korean Patent Application No. 10-2007-0092696, filed on Sep. 12, 2007, which is hereby incorporated by reference for all purposes as if fully set forth herein.

### BACKGROUND OF THE INVENTION

1. Field of the Invention

The present invention relates to a liquid crystal display (LCD) and, more particularly, to an LCD that may improve the stabilizing speed of texture.

2. Discussion of the Background

Liquid crystal displays (LCDs) are one of the most widely used types of flat panel displays (FPDs). An LCD includes two substrates, on which electrodes are disposed, and a liquid crystal layer interposed between the two substrates. Voltages are applied to the electrodes, and an electric field is generated in the liquid crystal layer. The liquid crystal molecules of the liquid crystal layer are aligned according to the electric field, and thus, the polarization of the incident light may be controlled, so that an image is displayed.

Among LCDs, vertical alignment (VA) mode LCDs have a large contrast ratio and a wide viewing angle and are in demand. The liquid crystal molecules of a VA mode LCD align such that a long axis of the liquid crystal molecules is vertical to both display panels in the absence of an electric field. To realize a wide-viewing angle in a VA mode LCD, a plurality of gaps or a plurality of protrusions may be formed on field-generating electrodes.

LCDs in which both display panels have a gap are vulnerable to static electricity, and alignment errors of both display panels may occur. For this reason, patternless VA mode LCDs, which have no pattern on the upper display panel, have been studied. However, in these LCDs, texture may be generated at a domain boundary.

Therefore, a method of forming a director control electrode (DCE) on the pixel electrode is being studied. However, this method may be unable to easily stabilize texture.

Therefore, a method of improving the speed of stabilizing texture is needed.

### SUMMARY OF THE INVENTION

The present invention relates to a liquid crystal display (LCD) that may improve the speed of stabilizing texture.

Additional features of the invention will be set forth in the description which follows, and in part will be apparent from the description, or may be learned by practice of the invention.

The present invention discloses an LCD including a first substrate, a pixel electrode disposed on the first substrate and including a plurality of domain-forming units, a pixel-electrode-insulating film disposed on the pixel electrode, and a director control electrode disposed on the pixel-electrode-insulating film positioned between the plurality of domain-forming units.

The present invention also discloses an LCD including a first substrate, a pixel electrode disposed on the first substrate and including a plurality of domain-forming units, a pixel-electrode-insulating film disposed on the pixel electrode, and a director control electrode disposed on the pixel-electrode-insulating film positioned between the plurality of domain-forming units.

The present invention also discloses an LCD including a first substrate, a pixel electrode disposed on the first substrate and including a plurality of domain-forming units and slits disposed between the plurality of domain-forming units, and a director control electrode disposed in the slits so. The director control electrode has a plurality of notches and does not contact the pixel electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view of a thin film transistor array panel of an LCD according to a first exemplary embodiment of the present invention.

FIG. 2 is a cross-sectional view of the LCD having the thin film transistor array panel, taken along line A-A′ of FIG. 1.

FIG. 3 is a cross-sectional view of the LCD having the thin film transistor array panel, taken along line B-B′ of FIG. 1.

FIG. 4 is an enlarged view of a director control electrode having notches, included in the LCD according to a first exemplary embodiment of the present invention.

FIG. 5 is a cross-sectional view of the LCD having the thin film transistor array panel, taken along line C-C′ of FIG. 1.

FIG. 6A, FIG. 6B, FIG. 7A, and FIG. 7B are pictures comparing texture of the LCD of according to a first exemplary embodiment of the present invention with that of a notchless LCD.

FIG. 8 is a layout view of a thin film transistor array panel of an LCD according to a second exemplary embodiment of the present invention.

FIG. 9 is a cross-sectional view of the LCD having the thin film transistor array panel, taken along line D-D′ of FIG. 8.

FIG. 10 is a layout view of a thin film transistor array panel of an LCD according to a third exemplary embodiment of the present invention.

FIG. 11 is a cross-sectional view of the LCD having the thin film transistor array panel, taken along line E-E′ of FIG. 10.

FIG. 12 is a layout view of a thin film transistor array panel of an LCD according to a fourth exemplary embodiment of the present invention.

FIG. 13 is a cross-sectional view of the LCD having the thin film transistor array panel, taken along line F-F′ of FIG. 12.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Spatially relative terms, such as “below,” “beneath,” “lower,” “above,” “upper,” and the like, may be used herein for ease of description to describe one device or element's relationship to another device(s) or element(s) as illustrated in the drawings. It will be understood that the spatially relative terms are intended to encompass different orientations of the device in use or operation in addition to the orientation depicted in the drawings.

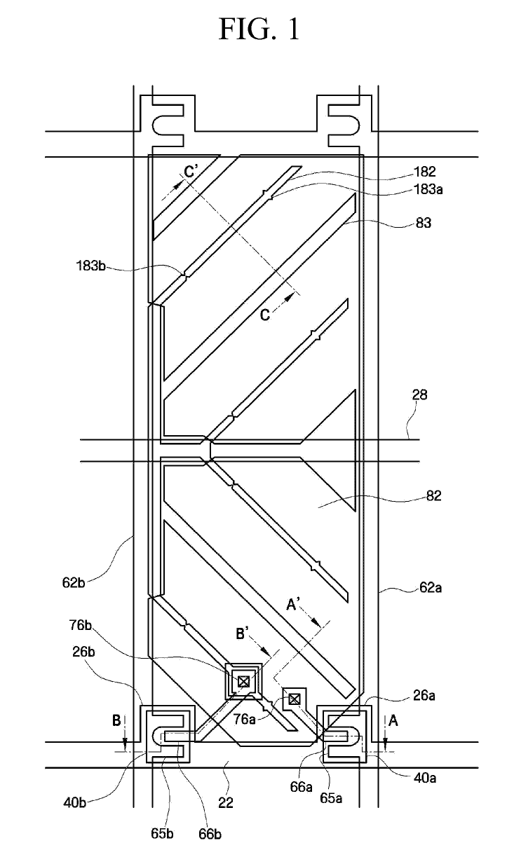

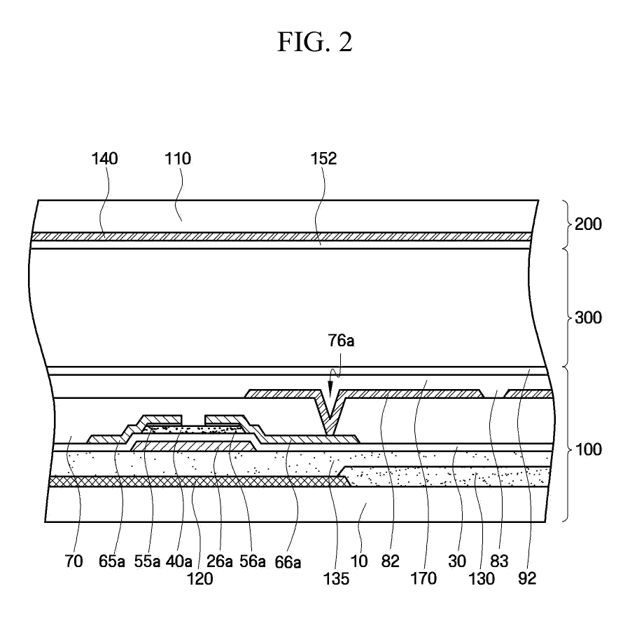

Hereinafter, a liquid crystal display (LCD) according to a first exemplary embodiment of the present invention will be described with reference to FIG. 1 and FIG. 2. FIG. 1 is a layout view of a thin film transistor array panel of an LCD according to a first exemplary embodiment of the present invention. FIG. 2 is a cross-sectional view of the LCD having the thin film transistor array panel, taken along line A-A′ of FIG. 1.

The LCD according to the first exemplary embodiment includes a thin film transistor array panel 100, a common electrode panel 200 facing the thin film transistor array panel 100, and a liquid crystal layer 300 interposed between the thin film transistor array panel 100 and the common electrode panel 200.

Referring to FIG. 1 and FIG. 2, color filters 130, pixel electrodes 82, and so forth may be disposed on the thin film transistor array panel 100 included in the LCD according to the first exemplary embodiment of the present invention. The LCD according to the first exemplary embodiment of the present invention may have an Array On Color filter (AOC) structure in which a thin film transistor array, such as gate wirings, is disposed on the color filters 130, or a Color filter On Array (COA) structure in which the color filters 130 are disposed on the thin film transistor array panel 100. For explanatory convenience, an LCD having the AOC structure will now be described.

According to the thin film transistor array panel 100 of the LCD having the AOC structure, a black matrix 120, which defines a pixel region and may improve the picture quality by preventing light leakage, is disposed on a first insulating substrate 10. For example, the black matrix 120 may be made of metal (or metal oxide), such as chrome (Cr) or chrome oxide, organic black resist, and so forth. To maximize the aperture ratio, the black matrix 120 may be arranged to overlap gate lines and/or data lines.

Red, green, and blue color filters 130 are sequentially arranged on the pixel region defined by the black matrix 120. These color filters 130 allow only light of specified wavelengths to pass therethrough.

The color filters 130 may be made of a photosensitive organic material, e.g., photoresist. The color filters 130 may all have the same thickness or may have different step heights.

An overcoat layer 135, which levels the steps of the color filters 130, may be disposed on the color filters 130.

A gate line 22 that extends in a horizontal direction to transfer a gate signal may be disposed on the overcoat layer 135. One gate line 22 is allocated to each pixel. A pair of first and second protruding gate electrodes 26a and 26b is disposed on the gate line 22. The gate line 22 and the first and second gate electrodes 26a and 26b constitute a gate wiring.

A storage line 28 is also disposed on the first insulating substrate 10. The storage line 28 extends horizontally and is substantially parallel to the gate line 22. In addition, the storage line 28 partially overlaps with a pixel electrode 82 (described hereinafter) in a pixel region. In the exemplary embodiment of FIG. 1, the storage line 28 overlaps the center of the pixel region. However, if sufficient storage capacitance is generated by the overlapping of the pixel electrode 82 and the storage line 28, the shape and disposition of the storage line 28 may vary.

The gate wiring 22, 26a, and 26b and the storage line 28 may include an aluminum (Al)-based metal, such as aluminum or an aluminum alloy, a silver (Ag)-based metal, such as silver or a silver alloy, a copper (Cu)-based metal, such as copper or a copper alloy, a molybdenum (Mo)-based metal, such as molybdenum or a molybdenum alloy, chrome (Cr), titanium (Ti), or tantalum (Ta).

In addition, the gate wiring 22, 26a, and 26b and the storage line 28 may each have a multi-film structure composed of two conductive films (not shown) having different physical characteristics. One of the two conductive films may include metal with low resistivity, such as an aluminum-based metal, silver-based metal, or copper-based metal, to reduce a signal delay or a voltage drop of the gate wiring and the storage line.

The other of the conductive films may include a different material, in particular, a material having superior contact characteristics with indium tin oxide (ITO) and indium zinc oxide (IZO), such as molybdenum-based metal, chrome, titanium, or tantalum. Examples of the multi-film structure include a combination of a chrome lower film and an aluminum upper film and a combination of an aluminum lower film and a molybdenum upper film. However, the gate wiring 22, 26a, and 26b and the storage line 28 may include various metals and conductors.

A gate insulating film 30, which may include silicon nitride (SiNₓ) or silicon oxide (SiOₓ), is disposed on the gate wiring 22, 26a, and 26b and the storage line 28.

A pair of semiconductor layers 40a and 40b, which may include hydrogenated amorphous silicon or polycrystalline silicon, are disposed on the gate insulating film 30. The semiconductor layers 40a and 40b may each have any of various shapes, such as an island shape or a stripe shape. Referring to FIG. 1, the semiconductor layers 40a and 40b on the gate electrodes 26a and 26b may have island shapes.

In another exemplary embodiment of the present invention, the semiconductor layers 40a and 40b may be formed in a stripe shape, may be disposed under a first data line 62a and a second data line 62b, and may extend on gate lines 26a and 26b.

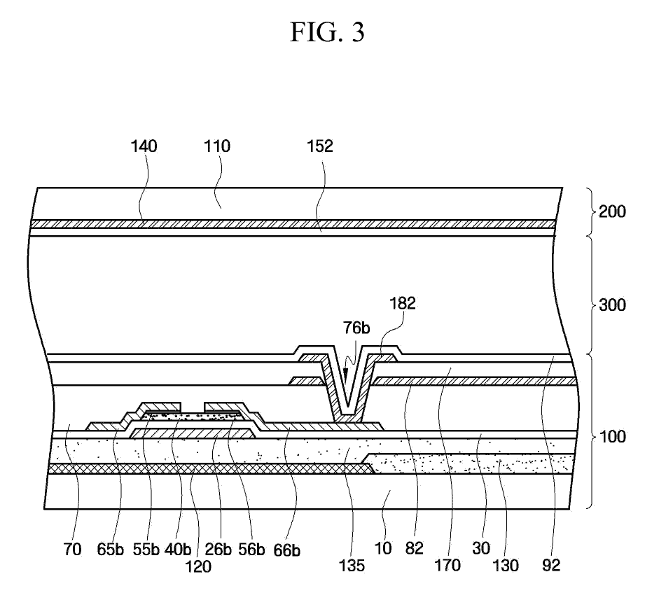

Ohmic contact layers 55a and 56a (refer to FIG. 2) and 55b and 56b (refer to FIG. 3), which may include silicide or n+ hydrogenated amorphous silicon doped with n-type impurities in high concentration, are disposed on the semiconductor layers 40a and 40b, respectively.

Ohmic contact layers 55a, 55b, 56a, and 56b may each have various shapes, such as an island shape or a stripe shape. For example, as shown in FIG. 2, the ohmic contact layers 55a and 56a may be island shaped and may be disposed under a drain electrode 66a and a source electrode 65a. Further, in another exemplary embodiment of the present invention, ohmic contact layers 55a and 55b having the stripe shape extend under the first data line 62a and the second data line 62b, respectively.

A pair of first and second data lines 62a and 62b and a pair of first and second drain electrodes 66a and 66b are disposed on the ohmic contact layers 55a and 56a and the gate insulating film 30. The first and second data lines 62a and 62b extend parallel to each other, for example, in a vertical direction, cross the gate line 22, and define the pixel region.

The first data lines 62a and the second data lines 62b are respectively connected to a first source electrode 65a and a second source electrode 65b extending toward the upside of the semiconductor layers 40a and 40b in the branch type. The first drain electrodes 66a and the second drain electrodes 66b are respectively spaced apart from the first source electrode 65a and the second source electrode 65b, which are respectively disposed on the semiconductor layers 40a and 40b to face the first source electrode 65a and the second source electrode 65b with respect to the gate electrodes 26a and 26b.

The first drain electrode 66a is connected to the pixel electrode 82 through a first contact hole 76a, and the second drain electrodes 66b is connected to the director control electrode 182 through a second contact hole 76b. Therefore, the pixel electrode 82 and the director control electrode 182 are supplied with the voltage from the first and second drain electrodes 66a and 66b, respectively.

The first and second data lines 62a and 62b, the first and second source electrodes 65a and 65b, and the first and second drain electrodes 66a and 66b are collectively referred to as data wiring.

The data wiring 62a, 62b, 65a, 65b, 66a, and 66b may include chrome, molybdenum-based metal, or refractory metal, such as tantalum or titanium. In addition, the data wiring 62a, 62b, 65a, 65b, 66a, and 66b may have a multi-film structure composed of a lower film (not shown), which may include refractory metal, and an upper film (not shown) which may include a combination of a chrome lower film and an aluminum upper film and a combination of an aluminum lower film and a molybdenum upper film. Alternatively, the multi-film structure may be a triple-film structure having molybdenum-aluminum-molybdenum films.

The first and second source electrodes 65a and 65b at least partially overlap the semiconductor layers 40a and 40b, respectively. In addition, the first and second drain electrodes 66a and 66b respectively face the first and second source electrodes 65a and 65b with respect to the gate electrodes 26a and 26b and at least partially overlap the semiconductor layers 40a and 40b, respectively. The ohmic contact layers 55a and 56a, 55b and 56b are disposed between the semiconductor layers 40a and 40b, the first and second source electrodes 65a and 65b, and the first and second drain electrodes 66a and 66b, respectively. The ohmic contact layers 55a and 56a, 55b and 56b may reduce contact resistance.

A passivation layer 70 is disposed on the data wiring 62a, 62b, 65a, 65b, 66a, and 66b and exposed portions of the semiconductor layers 40a and 40b. The passivation layer 70 may include an inorganic material, such as silicon nitride or silicon oxide, an organic material having photosensitivity and superior planarization characteristics, or a low dielectric material formed by plasma enhanced chemical vapor deposition (PECVD), such as a-Si:C:O or a-Si:O:F. For example, the passivation layer 70 may include a lower inorganic layer and an upper organic layer to protect the exposed portions of the semiconductor layers 40a and 40b while taking advantage of the superior characteristics of an organic layer.

First and second contact holes 76a and 76b, exposing the first and the second drain electrodes 66a and 66b respectively, are formed in the passivation layer 70.

The pixel electrode 82, which is connected to the first drain electrode 66a through the first contact hole 76a, is disposed on the passivation layer 70. The pixel electrode 82 is supplied with the data voltage from the first drain electrode 66a. The pixel electrode 82 may include a transparent conductive material, such as Indium Tin Oxide (ITO) or Indium Zinc Oxide (IZO).

The pixel electrode 82 is partitioned by a plurality of the domain-forming units 83. The plurality of the domain-forming units 83, for example, may be gaps formed by patterning the pixel electrode 82, or may be protrusions. The shape of the domain-forming units 83 should not be limited to those described above.

As shown in FIG. 1, the plurality of the domain-forming units 83 includes transverse parts and slanting parts. Transverse parts are formed transversely in a position dividing the pixel electrode 82 into an upper portion and a lower portion. The slanting parts are formed slantingly in the upper portion and the lower portion.

The slanting parts of the upper portion and the lower portion are arranged vertically to uniformly disperse the orientation of the horizontal electric field in four orientations.

The slanting parts include a part inclined at an angle of 45 degrees and a part inclined at an angle of −45 degrees. The domain-forming units 83 are substantially symmetrical with respect to the line (parallel to the gate line) dividing the pixel region into an upper part and a lower part.

For example, as shown in FIG. 1, the slanting parts of the domain-forming units 83 that are substantially inclined at the angle of 45 degrees are formed in the pixel electrode 82 positioned in an upper position from the center of the pixel. The slanting parts of the domain-forming units 83 that are substantially inclined at the angle of −45 degrees are formed in the pixel electrode 82 positioned below the center of the pixel. However, the LCD according to the invention is not limited to the above. When the slanting parts of the domain-forming units 83 are inclined to the gate line 22 at the angle of 45 or −45 degrees, the shape and position of the slanting parts of the domain-forming units 83 can be changed.

When the domain-forming units 83 of the pixel electrode 82 and a director control electrode 182 (to be described later) are used, a display area of the pixel electrode 82 is partitioned into a plurality of the domains according to the arranged orientation of the main director of the liquid crystal (refer to 310 of FIG.5) included in the liquid crystal layer 300 by applying the electric field. Here, the domain means the area of the liquid crystal including the main director inclined toward a determined orientation by the electric field generated between the pixel electrode 82 and the common electrode 140.

The voltage for driving the liquid crystals is applied to the pixel electrode 82. The voltage applied to the pixel electrode 82 may be lower than the voltage applied to the director control electrode 182 (to be described later).

Hereinafter, an insulating film, the director control electrode, a vertical alignment film, and the common electrode panel included in the LCD according to a first exemplary embodiment of the present invention will be described with reference to FIG. 1 and FIG. 3. FIG. 3 is a cross-sectional view of the LCD, having the thin film transistor array panel, taken along line B-B′ of FIG. 1.

Referring to FIG. 1 and FIG. 3, a pixel-electrode-insulating film 170 is disposed on the pixel electrode 82.

The pixel-electrode-insulating film 170 may include inorganic compounds, such as silicon nitride or silicon oxide, or organic compounds, such as acrylic group resin. The pixel-electrode-insulating film 170 is disposed between the director control electrode 182 and the pixel electrode 82.

The pixel-electrode-insulating film 170 prevents the director control electrode 182 and the pixel electrode 82 from being short-circuited. Therefore, as long as the pixel-electrode-insulating film 170 prevents a short circuit, the thickness of the pixel-electrode-insulating film 170 may be as thin as possible, for example, in the range of 5 to 200 nm.

The pixel-electrode-insulating film 170 according to the first exemplary embodiment of the present invention is disposed on the pixel electrode 82 and the passivation layer 70, and covers the whole surface of the first insulating substrate 10. Therefore, a process of patterning the pixel-electrode-insulating film 170 is not necessary, and the processing time may be reduced.

The director control electrode 182 is disposed on the pixel-electrode-insulating film 170 and insulated from the pixel electrode 82. The director control electrode 182 includes transverse parts and slanting parts. Transverse parts are formed transversely and divide the pixel electrode 82 into an upper portion and a lower portion. The slanting parts are formed slantingly in the upper portion and the lower portion of the pixel electrode 82.

In the present specification, the director control electrode 182 generally has slanting parts. The director control electrode 182 is disposed between the plurality of the domain-forming units 83, and may be disposed on the center of the pixel electrode 82 positioned between the adjacent domain-forming units 83. Specifically, the slanting parts of the domain-forming units 83 and the slanting parts of the director control electrode 182 may be disposed substantially at equal gaps in an alternating fashion.

The director control electrode 182 may include the same transparent electric conductor material as the pixel electrode 82. Therefore, though the direct control electrode 182 is disposed on the pixel electrode 82, the aperture ratio of the LCD may not be reduced. However, the width (refer to W1 of FIG. 5) of the director control electrode 182 may be 1˜12 μm in order to minimize an area in which texture is generated.

The director control electrode 182 is connected to the second drain electrode 66b through the second contact hole 76b. The voltage applied from the second data line 62b is transmitted to the director control electrode 182 via the second source electrode 65b and the second drain electrode 66b.

In the region where the second contact hole 76b is formed, the pixel electrode 82 is incised. Therefore, the pixel electrode 82 is not connected to the director control electrode 182. The voltage applied to the director control electrode 182 from the second data line 62b is higher than the voltage applied to the pixel electrode 82 from the first data line 62a. For example, the voltage applied to the pixel electrode 82 may be 6 V, and the voltage applied to the director control electrode 182 may be 8 V. The voltage variation of two electrodes may be at about 2 V to prevent texture from being transferred to the pixel electrode 82 by controlling texture.

The first vertical alignment film 92 aligning the liquid crystals may be disposed on the director control electrode 182 and the pixel-electrode-insulating film 170. The first vertical alignment film 92 and the second vertical alignment film 152 align the liquid crystal molecules of the liquid crystal layer 300. When a driving voltage is not applied to the LCD, black is displayed on the LCD. For example, the first vertical alignment film 92 may include a material having a main chain of a polyamide and a side chain.

The polarizer (not shown) may be disposed on the first insulating substrate 10. Specifically, the pixel electrode 82 may be disposed on one side of the first insulating substrate 10, and the polarizer may be disposed on the opposite side of the first insulating substrate 10. A polarizing axis of the polarizer disposed on the first insulating substrate 10 perpendicularly intersects a polarizing axis of the polarizer disposed on the second insulating substrate 110.

The common electrode panel 200, including the common electrode 140 that is not patterned, faces the film transistor array panel 100. Because the common electrode 140 is not patterned, a process for patterning the common electrode 140 on the common electrode panel 200 is not necessary. Therefore, a miss-alignment of the film transistor array panel 100 and the common electrode panel 200 may not occur. Further, anti-static treatment may not be necessary for the aperture ratio to be increased and the production cost may be reduced.

The second vertical alignment film 152 aligning the liquid crystal molecules vertically is disposed on the common electrode 140. “Cell gap” refers to the gap between the film transistor array panel 100 and the common electrode panel 200. A spacer (not shown) maintaining the cell gap may be interposed between the film transistor array panel 100 and the common electrode panel 200.

The common electrode 140 is disposed on one side of the second insulating substrate 110, and the polarizer may be disposed on the opposite side of the second insulating substrate 110. The polarizing axis of the polarizer disposed on the first insulating substrate 10 perpendicularly intersects the polarizing axis of the polarizer disposed on the second insulating substrate 110.

The liquid crystal layer 300, which includes the liquid crystal molecules 310, a UV hardening monomer, and a UV hardening initiator, is interposed between the film transistor array panel 100 and the common electrode panel 200.

The liquid crystal molecules 310 may have negative dielectric anisotropy, for example, the liquid crystal molecules 310 may be nematic liquid crystal molecules. The UV hardening monomer, for example, may be an acrylate group monomer. The UV hardening initiator may be a material that can absorb UV light.

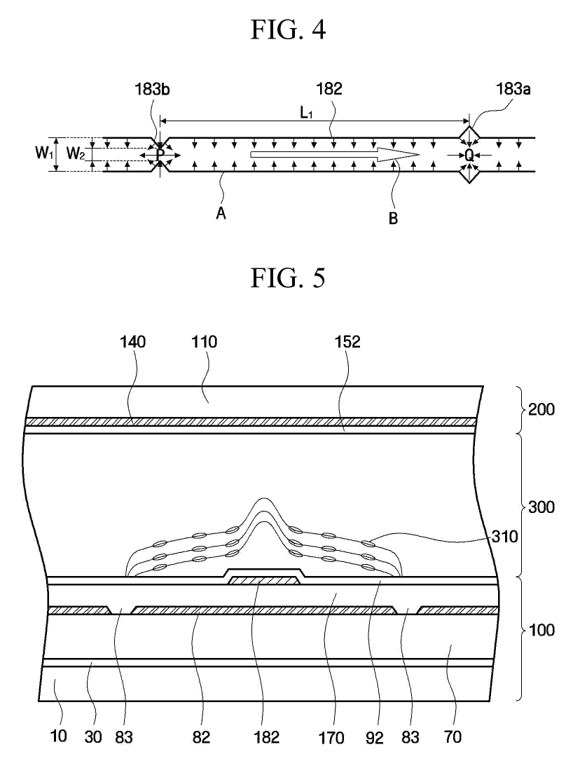

Hereinafter, the director control electrode and a notch included in the LCD according to a first exemplary embodiment of the present invention, as well as the alignment of the liquid crystal molecules by the above, will be described with reference to FIG. 1, FIG. 4 and FIG. 5. FIG. 4 is an enlarged view of a director control electrode that has notches and is included in the LCD of according to a first exemplary embodiment of the present invention. FIG. 5 is a cross-sectional view of the LCD having the thin film transistor array panel, taken along line C-C′ of FIG. 1.

As shown in FIG. 1 and FIG. 4, a plurality of notches 183a and 183b may be disposed on the director control electrode 182. The plurality of notches 183a and 183b are arranged along at least one side of the director control electrode 182. That is, the plurality of the notches 183a and 183b may be arranged along both sides of the director control electrode 182. The plurality of notches 183a and 183b may be protrusion notches 183a or recess notches 183b. The protrusion notches 183a may protrude toward the domain-forming units 83 from both sides of the director control electrode 182. The recess notches 183b may be recessed from both sides of the director control electrode 182.

The plurality of notches 183a and 183b disposed on the director control electrode 182 may include only the protrusion notch 183a, only the recess notch 183b, or both. The protrusion notch 183a and the recess notch 183b may be disposed along the one side or both sides of the director control electrode 182 in an alternating fashion.

The plurality of notches 183a and 183b formed on the slanting parts of the director control electrode 182 may be arranged along at least one side of the director control electrode 182 at 20 to 50 μm intervals (L₁).

The plurality of notches 183a and 183b arranged on one side of the director control electrode 182 may face the plurality of notches 183a and 183b arranged on the other side of director control electrode 182. When two recess notches 183b face each other, the recess notches 183b may be spaced apart by 2 to 5 μm (W₂). Here, a width (W₁) of the director control electrode 182 is greater than the distance (W₂) between two facing recess notches 183b.

The notches 183a and 183b may each be shaped like a polygon, such as a triangle, a quadrangle, a rhombus, or a semicircle. However, if the notches 183a and 183b have singular points P and Q and control the alignment of the liquid crystal molecules (refer to 310 of FIG. 5), the shapes of the notches 183a and 183b is not limited.

Considering the initial and final alignment of the liquid crystal molecules (refer to 310 of FIG. 5) where the electric field is applied, the plurality of the notches 183a and 183b form singular points P and Q on the director control electrode 182 where the directors are gathered. This is so that the elastic energy is concentrated around the singular points P and Q, and the orientation A of heads of the liquid crystal molecules 310 is determined.

For example, a negative singular point P is formed on an area corresponding to the recess notch 183b. The orientation A of heads of the liquid crystal molecules 310 partly converges and partly diverges at the negative singular point P. A positive singular point Q is formed on an area corresponding to the protrusion notch 183a. The orientation A of heads of the liquid crystal molecules 310 partly converges at the positive singular point Q.

Accordingly, by alternately disposing the recess notch 183b and the protrusion notch 183a, the orientation A of the heads of the liquid crystal molecules 310 disposed at a domain boundary are oriented away from the negative singular point P and toward the positive singular point Q, and thus the liquid crystal molecules 310 can receive a driving force B.

By determining the orientation of the liquid crystal molecules 31 disposed in the domain boundary in advance, the phenomenon in which orientation distortion of the liquid crystal molecules 310 at the domain boundary extends inside of the pixel electrode 82 may be suppressed for the lapse of time during which the driving voltage is applied thereto.

Accordingly, the liquid crystal molecules 310 oriented by the director control electrode 182 may be stably and regularly oriented through the notches 183a and 183b, and thus texture generated at the domain boundary, as well as the luminance reduction occurring after the driving voltage is applied, may be quickly stabilized.

Although not shown in the drawing, the director control electrode 182 may be narrowed or widened in a specified region in a specified direction to stabilize texture generated at the domain boundary more quickly. For example, the width of the director control electrode 182 may increase going from the recess notch 183b to the protrusion notch 183a. In this case, the driving force (in B direction) to direct the heads of the liquid crystal molecules 310 from the negative singular point P formed on the recess notch 183b to the positive singular point Q formed on the protrusion notch 183a, may become greater. Accordingly, the liquid crystal molecules 310 disposed on the director control electrode 182 may be oriented more quickly, and texture may be stabilized more quickly.

Referring to FIG. 5, if an electric field is formed between the pixel electrode 82 and the common electrode 140, the liquid crystal molecules 310 have different directions in a plurality of domains formed by the domain-forming units 83. However, to minimize texture generation by predetermining the orientations of the liquid crystals 310 in a domain, i.e., in the pixel electrode 82 located between the domain-forming units 83, a director control electrode 182 is disposed between the domain-forming units 83. Since a higher voltage is applied to the director control electrode 182 than to the pixel electrode 82 as described above, an upper part of the director control electrode 182 has an electric potential that is greater than that of an upper part of the pixel electrode 82, resulting in equipotential surfaces being formed as indicated by lines that connect the liquid crystals 310 in FIG. 5. Accordingly, the alignment directions of the liquid crystals 310 on left and right sides of the director control electrode 182 become opposite to each other, and thus the domain in the pixel electrode 82 is divided into two parts, which may decrease texture generation.

Since the director control electrode 182 is disposed on an upper side of the pixel electrode 82 and is applied with the corresponding voltage through a different path, the voltage difference between the director control electrode 182 and the pixel electrode 82 is minimized, and the alignment of the liquid crystal molecules 310 is controlled to quickly stabilize texture. Accordingly, texture may be prevented from being transferred into the pixel electrode 82. Also, since the director control electrode 182 is positioned on an upper side of the pixel electrode 82, there is a voltage difference between the electrodes, even though the pixel-electrode-insulating film 170 interposed between the electrodes is thin, and thus texture may be quickly stabilized. In addition, the width of the director control electrode 182 (Refer to W₁ of FIG. 1) may be adjusted without lowering the aperture ratio, and this is advantageous in designing the director control electrode 182.

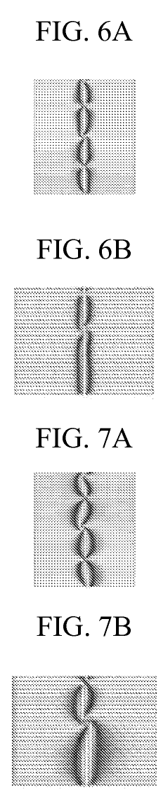

Hereinafter, with reference to FIG. 6A, FIG. 6B, FIG. 7A, and FIG. 7B, the texture control effect of the LCD that includes the director control electrode having notches formed thereon according to the first exemplary embodiment of the present invention will be described in comparison to that of a notchless LCD. FIG. 6A, FIG. 6B, FIG. 7A, and FIG. 7B compare the degree of texture generation in the LCD of according to the first exemplary embodiment of the present invention with that in a notchless LCD.

As shown in FIG. 6A, with an LCD including the director control electrode provided with notches according to an exemplary embodiment of the present invention, when 50 ms elapses after the driving voltage is applied, the singular points may be accurately fixed to the notch positions and the texture may be quickly stabilized. Also, as shown in FIG. 7A, according to the LCD of the present invention, it can be confirmed that texture stabilized and not transferred to the pixel electrode even when 1500 ms elapses after the driving voltage is applied. By contrast, as shown in FIG. 6B, with an LCD that is not provided with the notches but has only the director control electrode, texture becomes irregular when 50 ms elapses after the driving voltage is applied, and texture is transferred into the pixel electrode when 1500 ms elapses after the driving voltage is applied.

In addition, with an LCD having the director control electrode provided with the notches according to an exemplary embodiment of the present invention, the luminance reduction occurring after the driving voltage is applied may be quickly stabilized, and the transmissivity may be heightened.

The LCD includes a thin film transistor array panel 100, a common electrode panel 200, a liquid crystal layer 300 interposed between the thin film transistor array panel 100 and the common electrode panel 200, and a backlight assembly disposed on a lower part of the liquid crystal layer 300 and including a lamp.

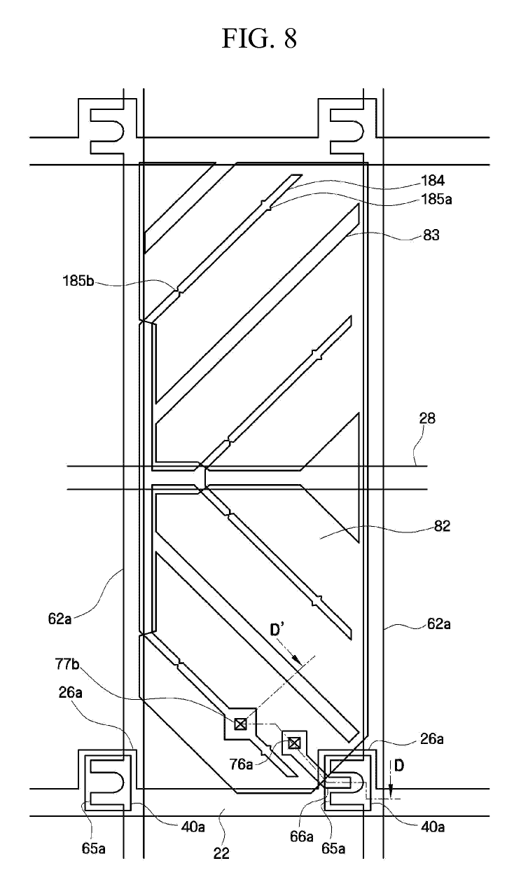

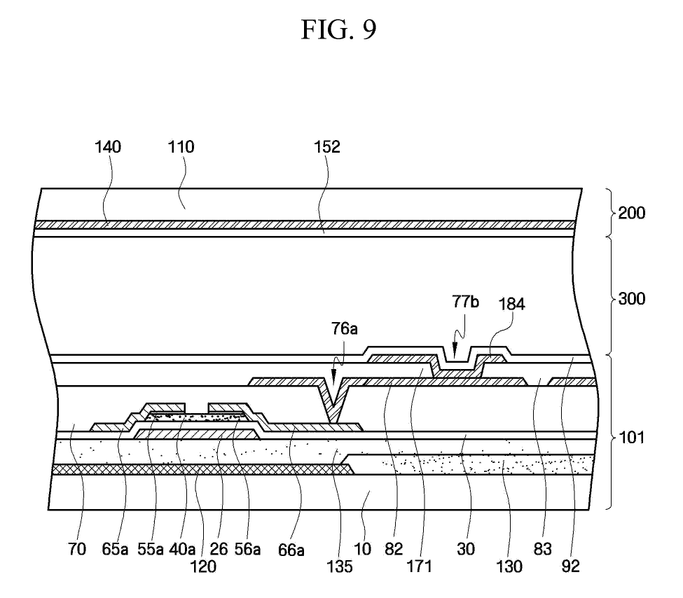

Hereinafter, with reference to FIG. 8 and FIG. 9, an LCD according to a second exemplary embodiment of the present invention will be described in detail. FIG. 8 is a layout view of a thin film transistor array panel of an LCD according to the second exemplary embodiment of the present invention, and FIG. 9 is a cross-sectional view of the LCD having the thin film transistor array panel, taken along line D-D′ of FIG. 8.

Referring to FIG. 8 and FIG. 9, the LCD according to the second exemplary embodiment of the present invention includes a director control electrode 184 connected to the pixel electrode 82.

In the thin film transistor array panel 101 of the LCD according to the second exemplary embodiment of the present invention, unlike the first exemplary embodiment of the present invention, there is one data line 62a for each pixel. Accordingly, there is a source electrode 65a and a drain electrode 66a for each pixel. The data line 62a and the source and drain electrodes 65a and 66a constitute a data wiring.

A signal applied from the data line 62a is transferred to the drain electrode 66a, which is connected to the pixel electrode 82 through a first contact hole 76a formed in the passivation layer 70, and the signal transferred to the drain electrode 66a is then transferred to the pixel electrode 82.

A pixel-electrode-insulating film 171 is arranged on the pixel electrode 82 and the passivation layer 70 to cover the whole surface of a first insulating substrate 10. In this exemplary embodiment of the present invention, the pixel-electrode-insulating film 171 serves to maintain the voltage difference between the pixel electrode 82 and the director control electrode 184. That is, in order for the director control electrode 184 disposed on the pixel electrode 82 to form a strong electric field and to form a new domain in the pixel electrode 82, the voltage of the director control electrode 184 should generate a stronger electric field than that generated by the voltage of the pixel electrode 82. Even if the same voltage is applied to the pixel electrode 82 and the director control electrode 184, the above-described difference in electric field strength may be maintained through a voltage drop caused by the pixel-electrode-insulating film 171. A second contact hole 77b is formed in the pixel-electrode-insulating film 171.

The director control electrode 184 is connected to the pixel electrode 82 through the second contact hole 77b formed in the pixel-electrode-insulating film 171. Accordingly, a signal applied from the data line 62a is transferred to the director control electrode 184 through the pixel electrode 82. However, even if the director control electrode 184 and the pixel electrode 82 receive the signal through the same data line 62a, the director control electrode 184 generates a stronger electric field than that of the pixel electrode 82 due to the voltage drop caused by the pixel-electrode-insulating film 171. Further, since the director control electrode 184 is not required to receive the voltage from a separate data line, the cutout of the pixel electrode 82 is not required to connect the director control electrode 184 to the separate data line.

In this exemplary embodiment of the present invention, a protrusion notch 185a or a recess notch 185b is formed on the director control electrode 184, and thus texture may be controlled even if the pixel-electrode-insulating film 171 is thin in comparison to the case when no notch is formed on the director control electrode 184.

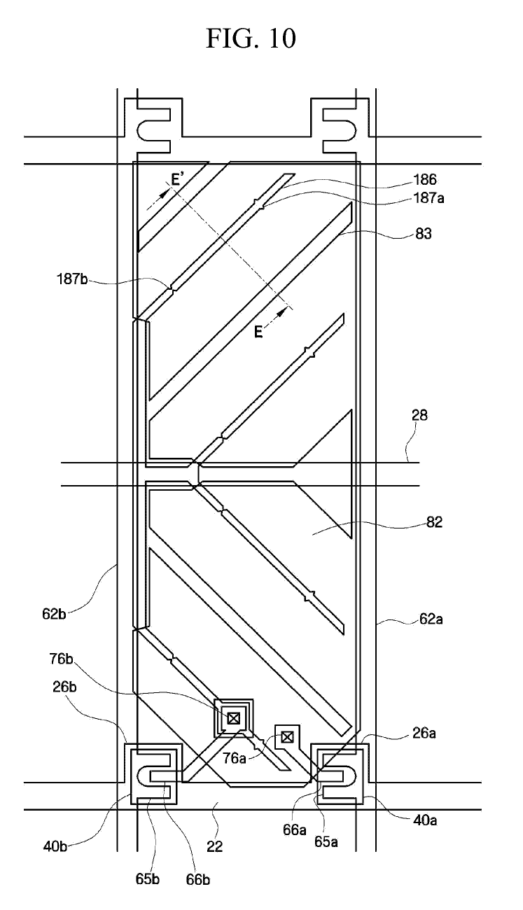

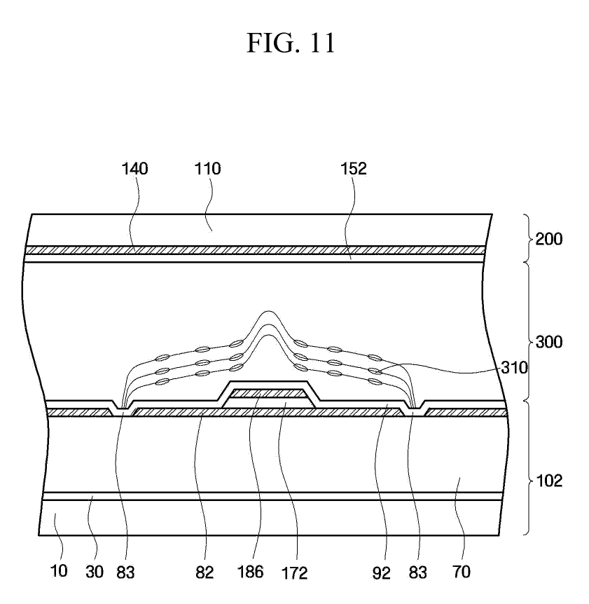

Hereinafter, with reference to FIG. 10 and FIG. 11, an LCD according to a third exemplary embodiment of the present invention will be described in detail. FIG. 10 is a layout view of a thin film transistor array panel of an LCD according to a third exemplary embodiment of the present invention, and FIG. 11 is a cross-sectional view of the LCD having the thin film transistor array panel, taken along line E-E′ of FIG. 10.

Referring to FIG. 10 and FIG. 11, a pixel-electrode-insulating film included in a thin film transistor array panel 102, according to the third exemplary embodiment of the present invention, may be a pixel-electrode-insulating pattern 172 patterned along a director control electrode 186.

The pixel-electrode-insulating pattern 172 protrudes from an upper part of the pixel electrode 82, and serves to prevent the pixel electrode 82 and the director control electrode 186 from being short-circuited and maintains the voltage difference between the electrodes. The height of the pixel-electrode-insulating pattern 172 may be adjusted according to the voltage applied to the pixel electrode 82 and the director control electrode 186. That is, as shown in FIG. 10, when the director control electrode 186 and the pixel electrode 82 receive the voltage from the second and first data lines 62b and 62a, the pixel-electrode-insulating pattern 172 may be as thin as possible. In this case, a portion of the pixel electrode 82, which is wider than the second contact hole 76b, may be cut out so that the pixel electrode 82 and the director control electrode 186 are not short-circuited. By contrast, if the pixel electrode 82 and the director control electrode 186 receive the same signal from the same data line (not shown), and the electric field generated by the pixel electrode 82 becomes less than that generated by the director control electrode 186 due to the pixel-electrode-insulating pattern 172, the pixel-electrode-insulating pattern 172 may be somewhat thick. However, even in this case, the director control electrode 186 according to this exemplary embodiment of the present invention includes a protrusion notch 187a and a recess notch 187b, and thus the thickness of the pixel-electrode-insulating pattern 172 is not significant.

The pixel-electrode-insulating pattern 172 may have a thickness greater than that of the director control electrode 186, and may be made of substantially the same material as that of the pixel-electrode-insulating film according to the first exemplary embodiment of the present invention (refer to 170 of FIG. 2).

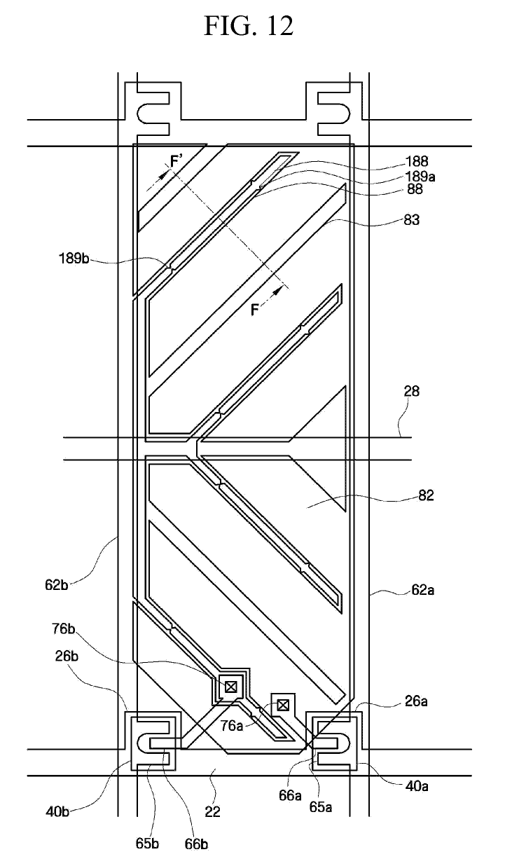

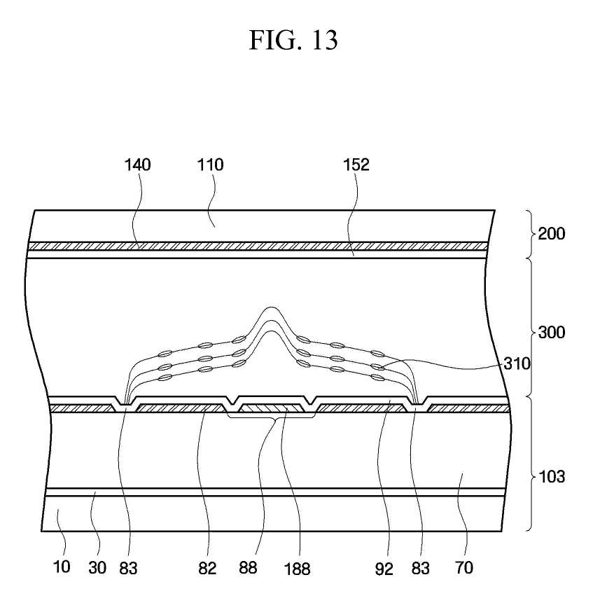

Hereinafter, with reference to FIG. 12 and FIG. 13, an LCD according to a fourth exemplary embodiment of the present invention will be described in detail. FIG. 12 is a layout view of a thin film transistor array panel of an LCD according to a fourth exemplary embodiment of the present invention, and FIG. 13 is a cross-sectional view of the LCD having the thin film transistor array panel, taken along line F-F′ of FIG. 12.

Referring to FIG. 12 and FIG. 13, the pixel electrode 82 included in a thin film transistor array panel 103 according to the fourth exemplary embodiment of the present invention may be partitioned by a plurality of domain-forming units 83 and a slit 88 disposed between the plurality of domain-forming units 83. The slit 88 is arranged alternately with the domain-forming units 83.

In this exemplary embodiment of the present invention, a director control electrode 188 is positioned inside the slit 88 so that it does not contact the pixel electrode 82. The director control electrode 188 has a width that is narrower than a width of the slit 88, and when a protrusion notch 189a is formed on the director control electrode 188, the sum of the widths of the director control electrode 188 and the protrusion notch 189a is set to be narrower than the width of the slit 88. For example, if the width of the director control electrode 188 is in the range of 1-12 μm, the slit 88 is formed a distance from the protrusion notch 189a that corresponds to the width of the protrusion notch 189a.

In the fourth exemplary embodiment of the present invention, the director control electrode 188 may be positioned on the same layer as the pixel electrode 82. Also, the director control electrode 188 and the pixel electrode 82 may be made of the same material. Accordingly, the pixel electrode 82 and the director control electrode 188 may be formed in a process by patterning the same transparent electric conductor. A recess notch 189b and a protrusion notch 189a, which have substantially the same disposition interval, width, and shape as those according to the first exemplary embodiment of the present invention, may be formed on the director control electrode 188. The director control electrode 188 and the notches 189a and 189b formed thereon are disposed apart from the edges of the slit 88 to prevent the short circuit with the pixel electrode 82.

In the fourth exemplary embodiment of the present invention, the director control electrode 188, which is not connected to the pixel electrode 82, receives a voltage grater than that of the pixel electrode 82, and controls texture.

As described above, the LCD according to the embodiments of the present invention produces one or more of the following effects.

First, the director control electrode includes a notch, and thus texture formed on an upper part of the director control electrode may be quickly stabilized.

Second, in the case where the director control electrode is disposed on an upper part of the pixel electrode, texture may be quickly stabilized even if the pixel-electrode-insulating film is thin.

Third, when the director control electrode is disposed on an upper part of the pixel electrode, the aperture ratio may be improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display (LCD), comprising:
a first substrate;
a pixel electrode disposed on the first substrate and comprising a plurality of domain-forming units;
a pixel-electrode-insulating film disposed on the pixel electrode; and
a director control electrode disposed on the pixel-electrode-insulating film and positioned between the plurality of domain-forming units.

2. The LCD of claim 1, wherein a thickness of the pixel-electrode-insulating film is in the range of 5 to 200 nm.

3. The LCD of claim 2, wherein the pixel-electrode-insulating film extends across the entire surface of the first substrate.

4. The LCD of claim 3, wherein the director control electrode is not electrically connected to the pixel electrode and a first voltage applied to the director control electrode is greater than a second voltage applied to the pixel electrode.

5. The LCD of claim 4, further comprising:
a first data wiring comprising a first data line, the first data wiring disposed on the first substrate; and
a second date wiring comprising a second data line arranged parallel to the first data line;
wherein the pixel electrode receives the second voltage from the first data line, and the director control electrode receives the first voltage from the second data line.

6. The LCD of claim 2, wherein the director control electrode is electrically connected to the pixel electrode.

7. The LCD of claim 6, further comprising a data wiring comprising a single data line for each pixel, the data wiring being disposed on the first substrate, wherein the pixel electrode receives a voltage from the data line.

8. The LCD of claim 2, wherein the pixel-electrode-insulating film is a pixel-electrode-insulating pattern patterned along the director control electrode.

9. The LCD of claim 8, wherein the width of the pixel-electrode-insulating pattern is greater than the width of the director control electrode.

10. The LCD of claim 1, wherein the director control electrode and the pixel electrode are made of the same transparent conductive material.

11. The LCD of claim 10, wherein the width of the director control electrode is in the range of 1 to 12 μm.

12. The LCD of claim 1, wherein the domain-forming units comprise a gap in the pixel electrode.

13. The LCD of claim 1, further comprising a second substrate facing the first substrate and comprising a non-patterned common electrode.

14. A liquid crystal display (LCD), comprising:
a first substrate;
a pixel electrode disposed on the first substrate and comprising a plurality of domain-forming units;
a pixel-electrode-insulating film disposed on the pixel electrode; and
a director control electrode having a plurality of notches, the director control electrode being disposed on the pixel-electrode-insulating film and positioned between the plurality of domain-forming units.

15. The LCD of claim 14, wherein the plurality of notches are arranged along at least one side of the director control electrode at a 20 to 50 μm interval.

16. The LCD of claim 15, wherein the notches are recess-notches or protrusion-notches, the notches are arranged along both sides of the director control electrode, and the notches arranged on one side of the director control electrode face the notches arranged on the other side of the director control electrode.

17. The LCD of claim 16, wherein a pair of the notches facing each other are recess notches, and a gap between the pair of notches is in the range of 3 to 5 μm.

18. A liquid crystal display (LCD), comprising:
a first substrate;
a pixel electrode disposed on the first substrate and comprising a plurality of domain-forming units and slits disposed between the plurality of domain-forming units; and
a director control electrode disposed in the slits, the director control electrode having a plurality of notches and not contacting the pixel electrode.

19. The LCD of claim 18, wherein the plurality of notches are arranged along at least one side of the director control electrode at 20 to 50 μm intervals.

20. The LCD of claim 19, wherein the notches are recess notches or protrusion notches, the notches are arranged along both sides of the director control electrode, and the notches arranged on one side of the director control electrode face to the notches arranged on the other side of the director control electrode.

21. The LCD of claim 20, wherein a pair of notches facing each other are recess notches, and a gap between the pair of the notches is in the range of 3 to 5 μm.

22. The LCD of claim 18, wherein the director control electrode is disposed on the same layer as the pixel electrode.

23. The LCD of claim 22, wherein the director control electrode is not connected to the pixel electrode, and a first voltage applied to the director control electrode is greater than a second voltage applied to the pixel electrode.

24. The LCD of claim 23, further comprising:
a first data wiring comprising a first data line, the first data wiring being disposed on the first substrate; and
a second date wiring comprising a second data line arranged parallel to the first data line;
wherein the pixel electrode receives the second voltage from the first data line, and the director control electrode receives the first voltage from the second data line.

25. The LCD of claim 22, wherein the director control electrode and the pixel electrode comprise the same transparent conductive material.

26. The LCD of claim 25, wherein the width of the director control electrode is in the range of 1 to 12 μm.
